(19) United States
(12) Patent Application Publication
(10) Pub. No.: US 2022/0353297 A1
(43) Pub. Date: Nov. 3, 2022

(54) METHOD AND SYSTEM FOR DISTRIBUTED POLICY-BASED SECURITY FOR CONNECTED DEVICES

(71) Applicant: Aeris Communications, Inc., San Jose, CA (US)

(72) Inventors: Narendra Sharma, Sunnyvale, CA (US); Drew S. Johnson, San Jose, CA (US); Richard Johnson, San Jose, CA (US); Amit Khetawat, San Jose, CA (US)

(21) Appl. No.: 17/732,157

(22) Filed: Apr. 28, 2022

Related U.S. Application Data
(60) Provisional application No. 63/182,368, filed on Apr. 30, 2021.

(51) Int. Cl. H04L 9/40

(52) U.S. Cl. CPC H04L 63/20

(57) ABSTRACT

A computer-implemented method, system, and computer program product for providing distributed policy-based security for one or more devices enabled for connectivity over a communications network are disclosed. The computer-implemented method for providing distributed policy-based security for one or more devices enabled for connectivity over a communications network includes providing a policy enforcement agent for each of one or more devices enabled for connectivity; providing policy rules to the policy enforcement agent, wherein the policy rules comprise one or more of: traffic filter policy rules, network access policy rules, power management policy rules and application management policy rules; and managing policy-based security for the one or more devices by the policy enforcement agent by applying the provided policy rules immediately or based on the provided criteria evaluated on the device.

### CROSS-REFERENCE TO RELATED APPLICATIONS

Under 35 USC 119(e), this application claims priority to U.S. provisional application Ser. No. 63/182,368, entitled “METHOD AND SYSTEM FOR DISTRIBUTED POLICY-BASED SECURITY FOR CONNECTED DEVICES”, filed on Apr. 30, 2021, which is incorporated herein by reference in its entirety.

### FIELD OF THE INVENTION

The present invention relates generally to providing distributed policy-based security for connected devices using communications network.

### BACKGROUND

Connected devices, whether phones, radios, sensors or other types of hardware, for example, Machine to Machine (M2M) or Internet of Things (IoT) devices, that are intended to connect to communications networks, such as wireless or cellular networks, are enabled to connect to networks, such as by use with products such as Subscriber Identification Modules (SIMs). As IoT solutions are being deployed in high volume, the need and demand to provide policy-based security to such devices is becoming stronger. In most cases, this security is provided by using authentication and authorization or through use of firewalls. However, such implementation may still leave the devices vulnerable to attacks from their own networks.

### SUMMARY

A computer-implemented method, system and computer program product for providing distributed policy-based security for one or more devices enabled for connectivity over communications network are disclosed. The computer-implemented method for providing distributed policy-based security for one or more devices enabled for connectivity over a communications network includes providing a policy enforcement agent for each of one or more devices enabled for connectivity; providing policy rules to the policy enforcement agent, wherein the policy rules comprise one or more of: traffic filter policy rules, network access policy rules, power management policy rules and application management policy rules; and managing policy-based security for the one or more devices by the policy enforcement agent by applying the provided policy rules immediately or based on the provided criteria evaluated on the device.

In an embodiment, the system for providing distributed policy-based security for one or more devices enabled for connectivity over a communications network includes devices enabled for connectivity, one or more IoT services, a usage analytics module/service, a policy management module/service, a policy enforcement agent, wherein the policy enforcement agent is provided policy rules comprising one or more of: traffic filter policy rules, network access policy rules, power management policy rules and application management policy rules; and the policy enforcement agent manages policy-based security for the one or more devices by applying the provided policy rules immediately or based on the provided criteria evaluated on the device.

In an embodiment, the computer program product stored on a non-transitory computer readable medium for providing distributed policy-based security for one or more devices enabled for connectivity over a communications network, comprising computer readable instructions for causing a computer to control an execution of an application for providing distributed policy-based security for one or more devices enabled for connectivity including: providing a policy enforcement agent for each of one or more devices enabled for connectivity; providing policy rules to the policy enforcement agent, wherein the policy rules comprise one or more of: traffic filter policy rules, network access policy rules, power management policy rules and application management policy rules; and managing policy-based security for the one or more devices by the policy enforcement agent by applying the provided policy rules immediately or based on the provided criteria evaluated on the device.

### BRIEF DESCRIPTION OF THE DRAWINGS

FIG. 1 illustrates an exemplary overview of process 100 for providing distributed policy-based security for one or more devices enabled for connectivity over communications network in accordance with an embodiment of the present invention.

FIG. 2 illustrates an exemplary overview of system 200 for providing distributed policy-based security for one or more devices enabled for connectivity over communications network in accordance with an embodiment of the present invention.

FIG. 3 illustrates an exemplary overview of system 300 for providing distributed policy-based security for one or more devices enabled for connectivity over communications network in accordance with an embodiment of the present invention.

FIG. 4 illustrates a data processing system 400 suitable for storing the computer program product and/or executing program code relating to providing distributed policy-based security for one or more devices enabled for connectivity over cellular or wireless network in accordance with one or more embodiments of the present invention.

### DETAILED DESCRIPTION

The present invention relates generally to providing distributed policy-based security for one or more devices, for example, Machine to Machine (M2M), Internet of Things (IoT) devices, etc. using communications network connectivity.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Although the invention is described with respect to product such as a Subscriber Identification Module (SIM), as used herein the term “product” is intended to be inclusive, interchangeable, and/or synonymous with appliances, electronic modules, telephony equipment and other similar products that require registration of distinct identifying numbers, such as ICCIDs, IMSIs, MElDs or other serial numbers as described further below and collectively referred to herein as “numbers”, for that product with a service provider to receive services, though one will recognize that functionally different types of products may have characteristics, functions and/or operations which may be specific to their individual capabilities and/or deployment.

Devices, whether phones, radios, sensors or other types of hardware, known as Machine to Machine (M2M) or Internet of Things (IoT) devices, that are intended to connect to networks, such as wireless or cellular networks, are enabled to connect to networks, such as by use with products such as Subscriber Identification Modules (SIMs). As IoT solutions are being deployed in high volume, the need and demand to providing policy-based security for such devices is becoming stronger. In most cases, this security is provided by using authentication and authorization or through use of firewalls. However, such implementation may still leave the devices vulnerable to attacks from their own networks or services vulnerable to attacks from their own devices, which may affect the enterprise's business and cost them millions of dollars overnight.

Accordingly, what are needed are system and method to address the above identified issues. The present invention addresses such a need.

To describe the features of the present invention in more detail within the context of connected devices, for example, M2M devices, IoT devices, etc. with products such as SIMs installed in them, for example, vehicles or sensors, refer to the accompanying figures in conjunction with the following discussions. These examples are used for purpose of illustration only, and should not be construed as limitations.

The embodiments described herein disclose a computer-implemented method, system and computer program product for providing distributed policy-based security for one or more devices enabled for connectivity over communications network.

A computer-implemented method, system and computer program product for providing distributed policy-based security for one or more devices enabled for connectivity over communications network are disclosed. The computer-implemented method for providing distributed policy-based security for one or more devices enabled for connectivity over a communications network includes providing a policy enforcement agent for each of one or more devices enabled for connectivity; providing policy rules to the policy enforcement agent, wherein the policy rules comprise one or more of: traffic filter policy rules, network access policy rules, power management policy rules and application management policy rules; and managing policy-based security for the one or more devices by the policy enforcement agent by applying the provided policy rules immediately or based on the provided criteria evaluated on the device.

In an embodiment, the system for providing distributed policy-based security for one or more devices enabled for connectivity over a communications network includes devices enabled for connectivity, one or more IoT services, a usage analytics module/service, a policy management module/service, a policy enforcement agent, wherein the policy enforcement agent is provided policy rules comprising one or more of: traffic filter policy rules, network access policy rules, power management policy rules and application management policy rules; and the policy enforcement agent manages policy-based security for the one or more devices by applying the provided policy rules immediately or based on the provided criteria evaluated on the device.

In an embodiment, the computer program product stored on a non-transitory computer readable medium for providing distributed policy-based security for one or more devices enabled for connectivity over a communications network, comprising computer readable instructions for causing a computer to control an execution of an application for providing distributed policy-based security for one or more devices enabled for connectivity including: providing a policy enforcement agent for each of one or more devices enabled for connectivity; providing policy rules to the policy enforcement agent, wherein the policy rules comprise one or more of: traffic filter policy rules, network access policy rules, power management policy rules and application management policy rules; and managing policy-based security for the one or more devices by the policy enforcement agent by applying the provided policy rules immediately or based on the provided criteria evaluated on the device.

IoT devices or M2M devices (collectively referred to herein as connected devices or devices) may use multiple technologies to connect to the internet for data exchange. For example, Wi-Fi, Cellular, Satellite etc. Any device that connects to the internet is prone to attack by hackers or even misuse by legitimate users. For example. hackers may exploit vulnerabilities in large numbers of IoT devices to launch DDoS attacks, or a driver of a vehicle owned by an enterprise may use the cellular connectivity available via the vehicle's connectivity unit for their personal use. Such hacks and misuse can cost the enterprise millions of dollars overnight.

Traditional security solutions involve protecting the cloud services via authentication and authorization, and eventually setting up firewalls to allow only certain ports. A security attack may still be able to exploit the open ports and interfaces to overwhelm the service and make it unusable by regular users. Such an attack can incur huge cloud costs in the form of compute time (wasteful processing), storage (wasteful logging), and network traffic (wasteful outgoing traffic). One way to address this is to set up an allow list (whitelist) for the cloud service to the list of IP addresses that are published by the connectivity providers. While this provides protection from hacks from other networks, it does not prevent attacks from other connected devices on the same network.

A complementary security solution is to push part of the problem to the connectivity provider. An endpoint of the IoT service in the cloud is shared with the connectivity provider to set up a traffic policy that allows only that customer's devices to connect to the provided endpoint. The endpoint could be a public endpoint or private endpoint (VPN). Although, it may significantly contain the attack path and cloud cost, this cannot prevent attacks from the customer's own devices, which still can incur millions of dollars in cloud and data costs overnight.

High data usage issues are not always the result of hacking. If the IoT service in the cloud is down for a planned or unplanned reason, and if the devices are not programmed to deal with edge cases (backoff timers and logic, incorrect interpretation of errors etc.), they can generate a lot of traffic resulting in a huge cost. In yet another case, the service may be up but the response being returned by the service is not valid, resulting in device querying for the same information again and again.

In summary, the high data usage may be caused by any one or more of: 1. Cloud IoT service(s) planned or unplanned downtime, 2. Security vulnerability exploit on the device for DDoS attack, 3. Inefficient or insufficient edge case handling on the device for issues in the network or cloud IoT service, 4. Misuse of WAN connectivity (on IoT device) by legit users via secondary devices connected or attached to IoT device. One of the effective solutions to the problem described above is to apply the security policy at the device level by a policy enforcement agent, also referred to herein as policy agent, (PA) provided on the device that communicates with the policy management service/module (PMS) in the backend to obtain policies/policy rules to be applied on the device.

A variety of policies/policy rules can be applied. For example: A. Traffic filter policy: This policy applies traffic filter rules to allow/deny traffic based on attributes like source IP, destination IP, protocol, port, etc. This can help filter out unwanted traffic; B. Network access policy: This policy can allow/deny access to the network for a configurable duration. This helps contain the issue and provide time to come up with a strategy. It also helps save power for resource-constrained or battery-operated devices; C. Power management policy: This policy can put the device into power-saving mode for a configurable duration. This can help save power for resource-constrained or battery-operated devices while the issue is being understood and the solution being devised; and D. Application management policy: This policy can stop/pause a specific application on the device for a configurable duration.

The various policies described above may be managed in various ways. For example, by applying pre-defined policies and/or by applying specific policies. To optimize the data cost and latency, the PMS can send commands to apply predefined policies, such as but not limited to: deny all traffic; allow all traffic; block all network access (data); deny all network access (data); put the device in sleep mode for a duration, etc. When applying specific policies, more specific policies can be sent to the device, which may be pre-defined or are defined as more network traffic data and more information about the network traffic is gathered/learned and may include: allow a subset of traffic and deny all others; deny a subset of traffic and allow all others; block network access (data) on certain APNs or networks (roaming) for specific duration, etc.

Additionaly, or alternatively, the policies may be applied based on a criteria, where, instead of applying the policy now, the agent applies the policy when the criteria is met, for example, deny traffic to a destination if the number of connection attempts within a given duration exceeds the given threshold, block network access (data) if the data usage within a given duration exceeds the given threshold, etc.

The policies can be learned in the cloud, on the device or both in combination, based on the data usage patterns and AI/ML (artificial intelligence and machine learning) techniques.

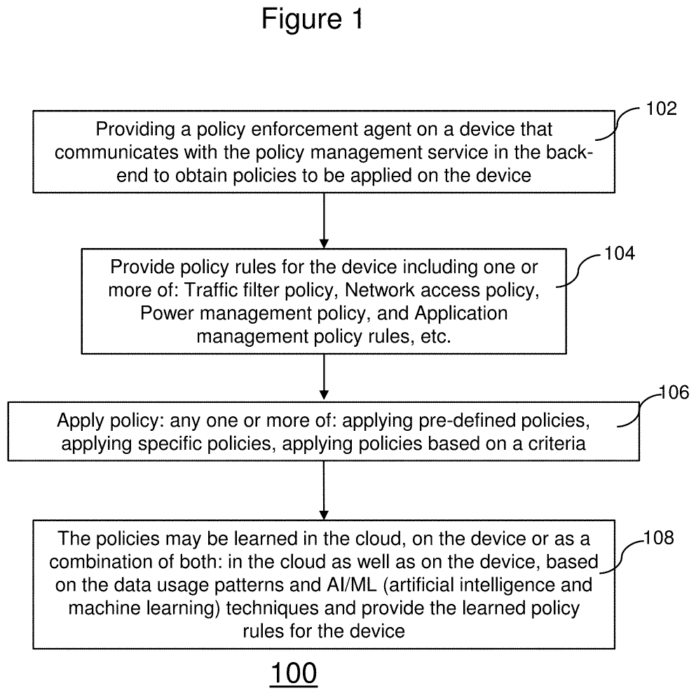

FIG. 1 illustrates an exemplary overview of process 100 for providing distributed policy-based security for one or more devices enabled for connectivity over communications network in accordance with an embodiment of the present invention. For example, in an embodiment, the method for providing distributed policy-based security for one or more devices enabled for connectivity over communications network includes applying the security policy at the device level.

The method for providing distributed policy-based security for one or more devices enabled for connectivity over communications network includes providing a policy enforcement agent, also referred to herein as policy agent, on a device via step 102 that communicates with the PMS in the backend to obtain policies/policy rules to be applied on the device.

A variety of policies/policy rules can be applied, for example, traffic filter policy/policy rules, which applies traffic filter rules to allow/deny traffic based on attributes like source IP, destination IP, protocol, port, etc. to help filter out unwanted traffic; network access policy/policy rules which allows/denies access to the network for a configurable duration, and helps contain the issue and provide time to come up with a strategy and also helps save power for resource-constrained or battery-operated devices; power management policy/policy rules which can put the device into power-saving move for a configurable duration and can help save power for resource-constrained or battery-operated devices while the issue is being understood and the solution being devised; and application management policy/policy rules: This policy can stop/pause a specific application on the device for a configurable duration via step 104.

The policies may be managed in various ways, for example: 1. by applying pre-defined general policies/policy rules: to optimize the data cost and latency, the PMS can send commands to apply predefined policies, such as but not limited to: deny all traffic; allow all traffic; block all network access (data); deny all network access (data); put the device in sleep mode for a duration, etc.; 2. by applying pre-defined specific policies/policy rules where, more specific policies can be sent to the device such as allow a subset of traffic and deny all others; deny a subset of traffic and allow all others; and block network access (data) on certain APNs or networks (roaming) for specific duration, etc.; 3. by applying policies/policy rules based on a specified criteria, where instead of applying the policy now, a criteria is provided to the policy enforcement agent which then applies the policy/policy rules when the criteria is met, for example, deny traffic to a destination if the number of connection attempts within a given duration exceeds the given threshold; block network access (data) if the data usage within a given duration exceeds the given threshold, etc., where the policies/policy rules may be based on various criteria, for example, deny traffic to a destination if the number of connection attempts within a given duration exceeds the given threshold; block network access (data) if the data usage within a given duration exceeds the given threshold, etc. via step 106.

The policy rules may be learned in the cloud, on the device or as a combination of both: in the cloud as well as on the device, based on the data usage patterns and AI/ML (artificial intelligence and machine learning) techniques via step 108.

Since the data usage profile for the device is known any departure from that pattern may be flagged as anomalous behavior and such attempts may be blocked for a pre-defined duration or at least until the back-end service overrides such blocking, etc., The learned policy rules may be pre-defined or are defined as more network traffic data and more information about the network traffic is gathered/learned and may be general policy rules, specific policy rules or criteria based policy rules. For example, the device encounters a new end point, which has not been accessed in a year, accompanied by high data usage, such usage may be flagged or may result in policy enforcement agent applying traffic filter policy rule by blocking it and generating an alert where the back-end services may then un-block it.

A person skilled in the art may readily understand that these rules are provided as examples and applying rules other than the ones listed herein would be within the spirit and scope of the present invention.

The policy rules may be learned in the cloud, on the device itself or as a combination of both: in the cloud as well as on the device, based on the data usage patterns and AI/ML (artificial intelligence and machine learning) techniques. While AI/ML based learning in the cloud is effective for deriving cross device aggregate data usage patterns, it is more effective from cost and performance to learn per device usage patterns in the device locally where device has the required computing and power resources. The usage analytics component/module to learn and analyze the data usage pattern could be implemented as separate application on the device or it could be part of the policy agent. For example, the analytics component/module can learn the usage pattern for a configurable duration and if it encounters a new endpoint being accessed or if the data usage rate towards an endpoint has increased significantly beyond normal, it can notify the policy agent which in turn can apply a policy rule to block the endpoint and generate a notification to the PMS in the cloud to trigger the business logic to evaluate if the access patterns is valid and accordingly notify the policy agent in the device to either maintain the rule or override that rule.

These policies/policy rules may be provided to the policy enforcement agent (PA) when the device is deployed and updated at pre-determined interval of time or when there is a change in policy/policy rules due to change in usage profile of the device or due to learning use/unuse of certain destination addresses by a specific device etc. In an embodiment, a notification to download new policies/policy rules may be sent to the device via control channel where the policy enforcement agent then downloads the updated policies/policy rules.

Thus, in an embodiment, the computer-implemented method for providing distributed policy-based security for one or more devices enabled for connectivity over a communications network includes providing a policy enforcement agent for each of one or more devices enabled for connectivity via step 102; providing policy rules to the policy enforcement agent, wherein the policy rules comprise one or more of: traffic filter policy rules, network access policy rules, power management policy rules and application management policy rules via step 104; and managing policy-based security for the one or more devices by the policy enforcement agent by applying the provided policy rules immediately or based on the provided criteria evaluated on the device via step 106. Additionally, the policies may be learned in the cloud, on the device itself or as a combination of both: in the cloud as well as on the device, based on the data usage patterns and AI/ML (artificial intelligence and machine learning) techniques and provide the learned policy rules for the device via step 108.

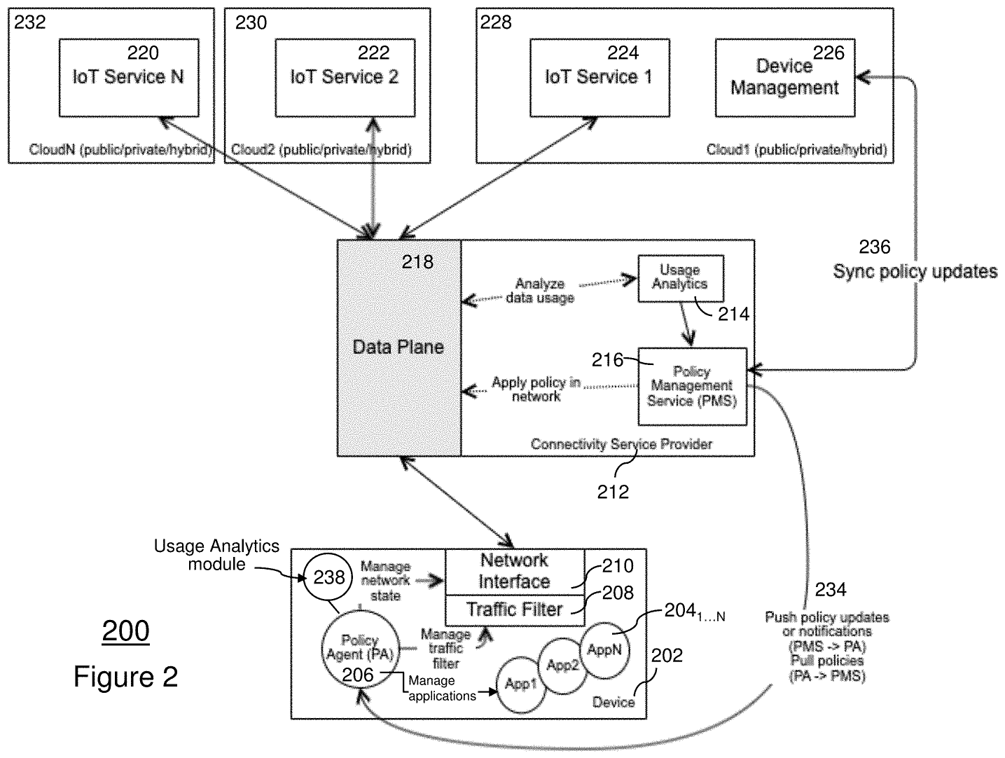

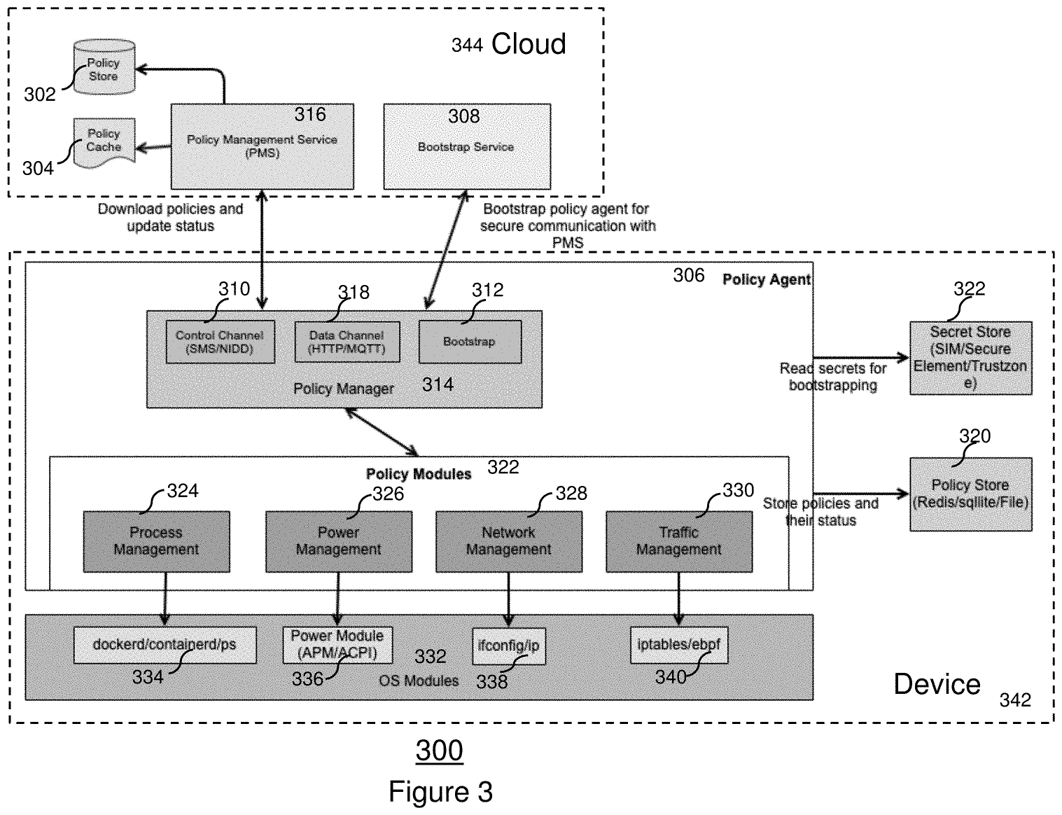

Various components of the system 200 used for carrying out the process described herein are illustrated in FIGS. 2 and 3 and are described in detail in the description accompanying FIGS. 2 and 3.

FIG. 2 illustrates an exemplary overview of system 200 for providing distributed policy-based security for one or more devices enabled for connectivity over communications network in accordance with an embodiment of the present invention. For example, in an embodiment, the system 200 may include one or more connected devices having one or more applications running on them, for example, App1, App2 . . . AppN etc., one or more IoT services, a device management module/service, a usage analytics module/service, a policy management module/service (PMS), a policy enforcement agent, also referred to herein as policy agent (PA), a network interface and a traffic filter.

The IoT Services may be defined as a set of endpoints that the application in the device is programmed to access. One IoT device may run multiple applications and each application may access different service endpoint, over different protocol, hosted in different cloud instances. The device management module/service is responsible for managing device profile, attributes and metadata.

The usage analytics module/service 214 may include a set of services responsible for processing usage records (typically coming from packet gateway, firewall etc.) to analyze the access and data usage pattern for the device/s 202. The PMS 216 manages network access and data traffic policies for the IoT solution. There can be multiple policies with scope from entire IoT solution to per device policy. Each type of policies may be defined as per device and/or for a group of devices. For example, some policies may be defined for each device whereas some policies may be defined for a group of devices. The devices may be grouped based on certain features of and/or related to the devices, for example, device type, geographic location of the device, etc. Thus, in an embodiment, the policies may be defined for individual devices, a group of devices or a combination thereof.

The policy agent (PA) 206 may be defined as an agent on the device (a module having executable instructions) that runs on the device/s 202. It receives encoded and encrypted policy commands from the PMS 216 and executes them. The execution could be either immediate or based on criteria. The network Interface 210 is the IP network interface that applications 204_{1 . . . N} on the IoT device/s 202 that is used to access internet and data services.

The traffic filter 208 represents the filters applies to the traffic that passes through the network interface 210, and App1, App2 . . . AppN 204_{1 . . . N} are the applications (apps) that connect to IoT services, for example, 220, 222, 224 etc. in the cloud 232, 230, 228 respectively for data exchange.

The device management module/service 226 is responsible for managing device profile, attributes and metadata. The device management service interacts with the application on the device through the communication network. In an embodiment, IoT solution providers may use the device management service 226 as interface to manage policies in effect at the device via integration with PMS. For example, IoT Service 1 is the primary service provided by the IoT solution provider that owns the device and overall IoT solution. However, in practice a device may run more than one application that interact with other IoT services. For example, the primary application on the device may be location tracking application where App1 on the device sends periodic location updates to IoT service 1, and the device may also have Global Navigation Satellite System (GNSS) application App2 that connects to location service IoT service 2 to download the satellite data to enable faster TTFF (Time To First Fix).

The components described herein perform various functions described above in the description accompanying FIG. 1 and illustrated in FIG. 1, for example, a device 202 is provided with a PA 206 on a connected device 202 that communicates with the PMS 216 in the back-end to obtain policies to be applied to the traffic to and from the device 202. Network traffic policy rules for a device 202 are defined and provided to the PA 206 by the PMS 216, which may include one or more of: traffic filter policy/policy rules, network access policy/policy rules, power management policy/policy rules, application management policy/policy rules, etc.

These traffic policy rules may include pre-defined policies/policy rules, specific policies/policy rules and policies/policy rules based on a specified criteria. The pre-defined policies/policy rules optimize the data cost and latency, the PMS 216 may send commands to PA 206 to apply predefined policies, such as but not limited to: deny all traffic; allow all traffic; block all network access (data); deny all network access (data); put the device in sleep mode for a duration, etc. The specific policies/policy rules may be sent to the device such as allow a subset of traffic and deny all others; deny a subset of traffic and allow all others; and block network access (data) on certain APNs or networks (roaming) for specific duration, etc.

The policies/policy rules based on a specified criteria, where instead of applying the policy/policy rules now, a criteria is provided to the PA 206 which then applies the policy/policy rule when the criteria is met, for example, deny traffic to a destination if the number of connection attempts within a given duration exceeds the given threshold; block network access (data) if the data usage within a given duration exceeds the given threshold, etc. The policies/policy rules may be based on various criteria, for example, deny traffic to a destination if the number of connection attempts within a given duration exceeds the given threshold; block network access (data) if the data usage within a given duration exceeds the given threshold, etc.

The application management policy/policy rules can stop/pause a specific application on the device for a configurable duration if the application is misbehaving and such misbehavior of the application is causing either network outage or undue power consumption for the device itself.

A person skilled in the art may readily understand that these rules are provided as examples and applying rules other than the ones listed herein would be within the spirit and scope of the present invention.

The policy rules may be learned in the cloud, on the device itself or as a combination of both: in the cloud as well as on the device, based on the data usage patterns and AI/ML (artificial intelligence and machine learning) techniques. Since the data usage profile for the device is known/learned by usage analytics module 214 any departure from that pattern may be flagged as anomalous behavior and such attempts may be blocked for a pre-defined duration or at least until the back-end service overrides such blocking, etc. The usage analytics module 214 learns the data usage profile for the device 202, communicates the learned device data usage profile to the PMS 216, which in turn may send commands to PA 206 to apply the traffic policies to the device 202 based on various criteria described above.

The learned policy rules may be pre-defined or are defined as more network traffic data and more information about the network traffic is gathered/learned and may be general policy rules, specific policy rules or criteria based policy rules. For example, when the device 202 encounters a new end point, for example, IoT service N 220, which has not been accessed in a year, accompanied by high data usage, such usage may be flagged by usage analytics module 214 or may result in the PMS 216 sending a command to the PA 206 or based on the policy rules already provided to the PA 206 or by pushing policy/policy rule updates, for example, via SMS, or notifications to pull updated policies by the PMS 216 to PA 206 via step 234, for example, to apply traffic filter policy rules to block it and generating an alert where the back-end services may then decide to keep it blocked or un-block it based on other criteria.

The policy rules may be learned in the cloud or on the device itself or as a combination of both: in the cloud as well as on the device, based on the data usage patterns and AI/ML (artificial intelligence and machine learning) techniques, for example, using usage analytics module 238. While AI/ML based learning in the cloud is effective for deriving cross device aggregate data usage patterns, it is more effective from cost and performance to learn per device usage patterns in the device locally where device has the required computing and power resources. The usage analytics component/module 238 to learn and analyze the data usage pattern could be implemented as separate application on the device or it could be part of the PA. For example, the analytics component/module 238 may learn the usage pattern for a configurable duration and if it encounters a new endpoint being accessed or if the data usage rate towards an endpoint has increased significantly beyond normal, it may notify the PA 206 which in turn may apply a policy rule to block the endpoint and generate a notification to the PMS 216 in the cloud to trigger the business logic to evaluate if the access patterns is valid and accordingly notify the PA 206 in the device to either maintain the rule or override that rule.

These policies may be provided to the PA 206 when the device 202 is deployed and updated at pre-determined interval of time or when there is a change in policy due to change in usage profile of the device 202 or due to learning use/unuse of certain destination addresses by a specific device etc. In an embodiment, a notification to download new policies/policy rules may be sent to the device 202 via control channel where the PA 206 then downloads the updated policies/policy rules via step 234. The traffic filter 208 represents the filters applied to the traffic that passes through the network interface 210 based on the policy/policy rules provided to the PA 206 for the device 202.

Thus, in an embodiment, the system 200 for providing distributed policy-based security for one or more devices 202 enabled for connectivity over a communications network includes devices enabled for connectivity, one or more IoT services, 220, 222, 224 etc., a usage analytics module/service 214, a PMS 216, a PA 206, wherein the PA 206 is provided policy rules comprising one or more of: traffic filter policy rules, network access policy rules, power management policy rules and application management policy rules; and the PA 206 manages policy-based security for the one or more devices by applying the provided policy rules immediately or based on the provided criteria evaluated on the device. Additionally, the policies may be learned in the cloud, on the device or as a combination of both: in the cloud as well as on the device, based on the data usage patterns and AI/ML (artificial intelligence and machine learning) techniques using usage analytics module 214 which works in concert with PMS 216 and the learned policy rules may be provided for the device 202 by pushing policy updates or notifications to pull updated policies by the PMS 216 to PA 206 via step 234. Various components of the system 200 described herein are illustrated and described in detail in FIG. 3 and the description accompanying FIG. 3 below.

FIG. 3 illustrates an exemplary overview of system 300 for providing distributed policy-based security for one or more devices enabled for connectivity over communications network in accordance with an embodiment of the present invention. In an example embodiment, the policy enforcement on the device includes a policy enforcement agent, also referred to herein as policy agent, (PA) 306 on the device which is responsible for enforcing various types of policies. The PA 306 may include a policy manager 314 that is responsible for accepting the policy and based on the type of policy, use one or more appropriate modules to apply it from various policy modules illustrated as 322. The actual implementation of various modules and mechanism for applying it on the underlying device, network and operating system may vary based on hardware and operating system of the one or more devices.

For example, for process management on Linux, the process management module 324 may use dockerd, containerd or ps 334. For power management, the power management module 326 may use the power module 336 provided by underlying operating system (OS) that may be based on Advanced Power Management (APM) or Advanced Configuration and Power Interface (ACPI), or use AT commands for modem power modes. For network interface state management, a network management module 328 may use ifconfig and ip 338. For traffic management, a traffic management module 330 may use iptables and eBPF 340 to apply traffic rules. Although, these examples are provided to describe example implementations of the invention, a person skilled in the art may readily recognize that the actual implementation may differ as devices and operating systems evolve and is also within the scope and spirit of this invention.

In an embodiment, the PA 306 may additionally include a bootstrap module 312 to securely authenticate and obtain the credentials to communicate with policy management service/module (PMS) 316. The PA 306 may use both control channel 310 and data channel 318 to communicate with PMS 316. The control channel 310 may be responsible for receiving commands or just command notifications via the control channel 310 like SMS or NIDD (Non-IP Data Delivery) even when the device is not in IP session.

The data channel 318 may be used to communicate with the PMS 316 securely to obtain policies, also referred to herein as policy rules, to be applied and also to communicate the status of the policies when they are applied and/or updated on the device to the policy store 302.

The PMS 316 is responsible for distributing policies to the one or more devices and maintaining current status of policies at device level or group of devices level. Each type of policies may be defined as per device and/or for a group of devices. For example, some policies may be defined for each device whereas some policies may be defined for a group of devices. The devices may be grouped based on certain features of and/or related to the devices, for example, device type, geographic location of the device, etc. Thus, in an embodiment, the policies may be defined for individual devices, a group of devices or a combination thereof. The PMS 316 may include a database, for example, policy store 302 and in-memory cache, for example, policy cache 304 to hold the policies and their current and desired state and at least one processor.

The bootstrap service 308 is responsible for bootstrapping the PA 306. Bootstrapping involves authenticating the PA 306 and providing the credentials that can be used by the PA 306 to securely communicate with PMS 316. Different bootstrapping mechanisms like 2-factor authentication (2FA), x.509 certificate authentication, SIM based authentication or other mechanisms may be used.

As illustrated in FIG. 3, device 342 may be provided with a local policy store 320 to store policy and status; and a secret store 322 for storing secrets for bootstrapping, use of which may depend on the bootstrap mechanism used. For example, secret store 322 may be used for x.509 certificate authentication to store certificate and keys that are provisioned during manufacturing; but may not be used for 2-factor authentication or SIM-based authentication.

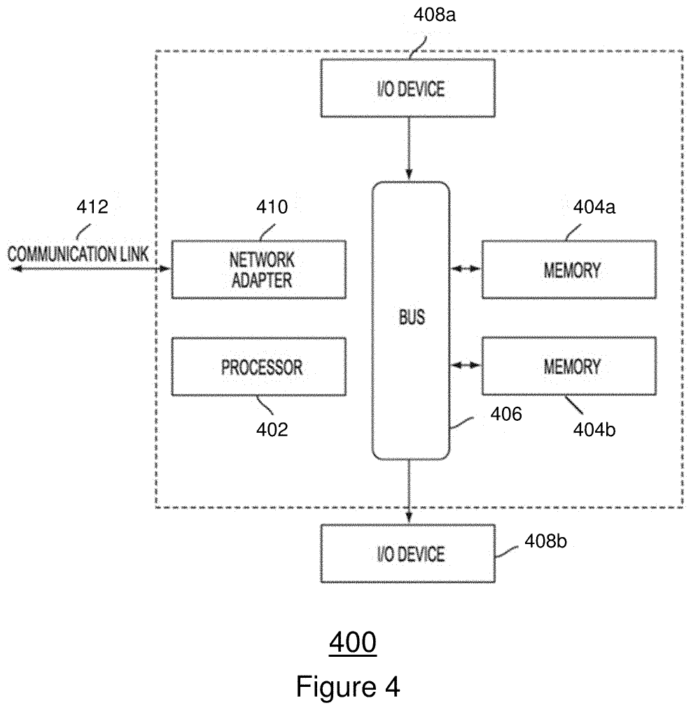

FIG. 4 illustrates a data processing system 400 suitable for storing the computer program product and/or executing program code in accordance with an embodiment of the present invention. In an embodiment, the computer program product stored on a non-transitory computer readable medium for providing distributed policy-based security for one or more devices enabled for connectivity over a communications network, comprising computer readable instructions for causing a computer to control an execution of an application for providing distributed policy-based security for one or more devices enabled for connectivity including: providing a policy enforcement agent (PA) for each of one or more devices enabled for connectivity; providing policy rules to the PA, wherein the policy rules comprise one or more of: traffic filter policy rules, network access policy rules, power management policy rules and application management policy rules; and managing policy-based security for the one or more devices by the PA by applying the provided policy rules.

The data processing system 400 includes a processor 402 coupled to memory elements 404a-b through a system bus 406. In an embodiment, the data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to the data processing system 400. I/O devices 408a-b may be coupled to the data processing system 400 directly or indirectly through intervening I/O controllers (not shown).

In FIG. 4, a network adapter 410 is coupled to the data processing system 402 to enable data processing system 402 to become coupled to other data processing systems or remote printers or storage devices through communication link 412. Communication link 412 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include digital versatile disk (DVD), compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, terminal, remote device, wireless asset, etc. are intended to be inclusive, interchangeable, and/or synonymous with one another and other similar communication-based equipment for purposes of the present invention though one will recognize that functionally each may have unique characteristics, functions and/or operations which may be specific to its individual capabilities and/or deployment.

Similarly, it is envisioned by the present invention that the term communications network includes communications across a network (such as that of a M2M but not limited thereto) using one or more communication architectures, methods, and networks, including but not limited to: Code Division Multiple Access (CDMA), Global System for Mobile Communications (GSM) (“GSM” is a trademark of the GSM Association), Universal Mobile Telecommunications System (UMTS), Long Term Evolution (LTE), fourth generation cellular systems (4G) LTE, 5G, wireless local area network (WLAN), and one or more wired networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer-implemented method for providing distributed policy-based security for one or more devices enabled for connectivity over a communications network comprises:
providing a policy enforcement agent for each of one or more devices enabled for connectivity;
providing policy rules to the policy enforcement agent, wherein the policy rules comprise one or more of: traffic filter policy rules, network access policy rules, power management policy rules and application management policy rules; and
managing policy-based security for the one or more devices by the policy enforcement agent by applying the provided policy rules immediately or based on the provided criteria evaluated on the device.

2. The method of claim 1, wherein the communications network comprises any one or more of: a cellular network, a wireless network and a satellite network.

3. The method of claim 1, wherein the policy rules are provided as pre-defined general policy rules; specific policy rules; or policy rules based on a specified criteria for the one or more devices, and wherein the pre-defined general policy rules and the specific policy rules are applied immediately to each of one or more devices enabled for connectivity; and policy rules based on a specified criteria for the one or more devices are applied when the specified criteria is satisfied.

4. The method of claim 3, wherein the pre-defined general policy rules for the one or more devices includes any one or more of: deny all network traffic; allow all network traffic; block all network access (data); deny all network access (data); put the device in sleep mode for a duration.

5. The method of claim 3, wherein the specific policy rules for the one or more devices includes any one or more of: allow a subset of traffic and deny all others; deny a subset of traffic and allow all others; and block network access on certain access point names (APNs) or certain networks for specific duration.

6. The method of claim 3, wherein the policy rules based on a specified criteria for the one or more devices includes any one or more of: deny traffic to a destination if the number of connection attempts within a given duration exceeds a pre-defined threshold and block network access if data usage within a given duration exceeds a pre-defined threshold.

7. The method of claim 1, further comprising learning data usage pattern for the one or more devices using machine learning in the cloud, learning data usage pattern for individual device using machine learning locally on the device or a combination thereof; and defining the policy rules based on learned data usage pattern.

8. The method of claim 1, wherein the policy rules are defined for individual devices, a group of devices or a combination thereof.

9. A system for providing distributed policy-based security for one or more devices enabled for connectivity over a communications network comprises one or more devices enabled for connectivity, one or more IoT services, a usage analytics module/service, a policy management module/service, a policy enforcement agent, wherein
the policy enforcement agent is provided with policy rules comprising one or more of: traffic filter policy rules, network access policy rules, power management policy rules and application management policy rules; and
the policy enforcement agent manages policy-based security for the one or more devices by applying the provided policy rules immediately or based on the provided criteria evaluated on the device.

10. The system of claim 9, wherein the communications network comprises any one or more of: a cellular network, a wireless network and a satellite network.

11. The system of claim 9, wherein the policy rules are provided as pre-defined general policy rules; specific policy rules; or policy rules based on a specified criteria for the one or more devices, and wherein the pre-defined general policy rules and the specific policy rules are applied immediately to each of one or more devices enabled for connectivity; and policy rules based on a specified criteria for the one or more devices are applied when the specified criteria is satisfied.

12. The system of claim 11, wherein the pre-defined general policy rules for the one or more devices includes any one or more of: deny all network traffic; allow all network traffic; block all network access (data); deny all network access (data); put the device in sleep mode for a duration.

13. The system of claim 11, wherein the specific traffic policy rules for the one or more devices includes any one or more of: allow a subset of traffic and deny all others; deny a subset of traffic and allow all others; and block network access on certain access point names (APNs) or certain networks for specific duration.

14. The system of claim 11, wherein the policy rules based on criteria for the one or more devices includes any one or more of: deny traffic to a destination if the number of connection attempts within a given duration exceeds a pre-defined threshold and block network access if data usage within a given duration exceeds a pre-defined threshold.

15. The system of claim 9, further comprising learning data usage pattern for the one or more devices using machine learning in the cloud, learning data usage pattern for individual device using machine learning locally on the device or a combination thereof; and defining the policy rules based on learned data usage pattern.

16. The system of claim 9, wherein the policy rules are defined for individual devices, a group of devices or a combination thereof.

17. A computer program product stored on a non-transitory computer readable medium for providing distributed policy-based security for one or more devices enabled for connectivity over a communications network, comprising computer readable instructions for causing a computer to control an execution of an application for providing distributed policy-based security for one or more devices enabled for connectivity comprising:
providing a policy enforcement agent for each of one or more devices enabled for connectivity;
providing policy rules to the policy enforcement agent, wherein the policy rules comprise one or more of: traffic filter policy rules, network access policy rules, power management policy rules and application management policy rules; and
managing policy-based security for the one or more devices by the policy enforcement agent by applying the provided policy rules immediately or based on the provided criteria evaluated on the device.

18. The computer program product of claim 17, wherein the communications network comprises any one or more of: a cellular network, a wireless network and a satellite network.

19. The computer program product of claim 17, wherein the policy rules are provided as pre-defined general policy rules; specific policy rules; or policy rules based on a specified criteria for the one or more devices, and wherein the pre-defined general policy rules and the specific policy rules are applied immediately to each of one or more devices enabled for connectivity; and policy rules based on a specified criteria for the one or more devices are applied when the specified criteria is satisfied.

20. The computer program product of claim 19, wherein the pre-defined general policy rules for the one or more devices includes any one or more of: deny all network traffic; allow all network traffic; block all network access (data); deny all network access (data); put the device in sleep mode for a duration.

21. The computer program product of claim 19, wherein the specific policy rules for the one or more devices includes any one or more of: allow a subset of traffic and deny all others; deny a subset of traffic and allow all others; and block network access on certain access point names (APNs) or certain networks for specific duration.

22. The computer program product of claim 19, wherein the policy rules based on specified criteria for the one or more devices includes any one or more of: deny traffic to a destination if the number of connection attempts within a given duration exceeds a pre-defined threshold and block network access if data usage within a given duration exceeds a pre-defined threshold.

23. The computer program product of claim 17, further comprising learning data usage pattern for the one or more devices using machine learning in the cloud, learning data usage pattern for individual device using machine learning locally on the device or a combination thereof; and defining the policy rules based on learned data usage pattern.

24. The computer program product of claim 17, wherein the policy rules are defined for individual devices, a group of devices or a combination thereof.
